(19) United States
(12) Patent Application Publication
(10) Pub. No.: US 2003/0027923 A1
(43) Pub. Date: Feb. 6, 2003

(54) High performance aqueous polyurethanes and methods of fabricating the same

(75) Inventors: Huey-Huey Lo, Taoyuan (TW); Wan-Hsiang Chen, Taichung (TW)

Correspondence Address: SUGHRUE, MION, ZINN, MACPEAK & SEAS, PLLC, 2100 Pennsylvania Avenue, N.W., Washington, DC, 20037-3213, US

(73) Assignee: INDUSTRIAL TECHNOLOGY RESEARCH INSTITUTE

(21) Appl. No.: 10/000,220

(22) Filed: Dec. 4, 2001

(30) Foreign Application Priority Data
Jul. 5, 2001 (TW) 90116443

(51) Int. Cl. C08K 3/00; C08L 75/00

(52) U.S. Cl. 524/839; 524/589

(57) ABSTRACT

Disclosed are high performance aqueous polyurethanes and methods of making the same. The aqueous polyurethane is prepared by prepolymerizing the following components (a), (b), and (c) in the absence of aliphatic or cycloaliphatic diisocyanates; and chain-extending the hydrophilic prepolymer with component (d): (a) 10-40 wt % of an aromatic diisocyanate; (b) 1-15 wt % of a compound containing active hydrogen and a hydrophilic group or a group capable of forming hydrophilicity; (c) 30-80 wt % of a polyol; and (d) 0.1-5 wt % of a chain extender having active hydrogen. The aqueous dispersions of the polyurethane have good storage stability and the dried films produced therefrom possess superior mechanical properties.

### BACKGROUND OF THE INVENTION

1. Field of the Invention

The present invention relates in general to aqueous polyurethanes (PU). More particularly, it relates to high performance aqueous polyurethanes and methods of making the same.

2. Description of the Related Arts

Polyurethane is a very important highly-functional resin. However, over 90 percent of polyurethanes contain quite a lot of organic solvent such as N,N-dimethylformamide or toluene, which pollutes the environment and endangers the health of operators. Since environment protection is gaining world-wide attention, and pollution laws are becoming stricter, the polyurethane resin industry has made revolutionary progress in recent years by using low-polluting aqueous polyurethanes instead of high-polluting, solvent type polyurethanes.

A conventional process for producing aqueous polyurethane resins includes prepolymerizing a polyol, a hydrophilic group-containing dihydric alcohol, and a diisocyanate in a high-boiling-point organic solvent; neutralizing the prepolymer with a tertiary amine to ionize the hydrophilic group; dispersing the neutralized prepolymer in water; and finally chain-extending the dispersed prepolymer to obtain aqueous polyurethane dispersions.

However, in the conventional process for producing an aqueous polyurethane, part of the terminal isocyanate (—NCO) groups of the prepolymer will be consumed by water upon dispersing, and converted into amino groups. As a result, the isocyanate groups cannot effectively react with a chain extender, a diamine for example, to extend the chains and raise the molecular weight, thus detrimentally affecting the physical properties of resulting polyurethanes. This problem is especially serious when the terminal groups are aromatic isocyanates, which are highly reactive with water. Thus, the polyurethanes derived from aromatic isocyanates are very poor in mechanical properties and have no commercial value.

Accordingly, even though aqueous polyurethanes have been commercialized for over than twenty years, all available products are derived from aliphatic or cycloaliphatic diisocyanates, which are less reactive with water, for example, isophorone diisocyanate (IPDI), hexamethylene diisocyanate (HDI), and 4,4′-dicyclohexylmethane diisocyanate (H₁₂MDI) However, because aliphatic and cycloaliphatic diisocyanates are quite expensive, using the derived aqueous polyurethanes costs much more than using conventional solvent-type polyurethanes, and this has significantly restricted their popularization in industry. Aqueous polyurethanes derived from low-cost aromatic diisocyanates are therefore desired. Before this, the problem of poor chain extension due to their high reactivity with water must be solved first.

Numerous attempts have been made to reduce the reactivity of terminal isocyanate groups with water by incorporating aliphatic or cycloaliphatic diisocyanates into aromatic diisocyanates. However, these methods cannot provide a real low-cost aqueous polyurethane. See, for example, U.S. Pat. Nos. 5,714,561, 5,852,105, 5,905,113, 5,334,690 and 5,231,130. Other conventional methods require either complicated process or large amounts of organic solvent. See, for example, U.S. Pat. Nos. 5,770,264, 5,470,907, 5,714,561, and 5,306,764.

### SUMMARY OF THE INVENTION

It is therefore an object of the invention to solve the above-mentioned problem and provide an aqueous polyurethane and a method of making the same.

It is another object of the invention to provide an aqueous polyurethane which is prepared in the absence of aliphatic or cycloaliphatic diisocyanates.

It is a further object of the invention to provide an aqueous polyurethane that has good storage stability aid superior mechanical properties.

It is a further object of the invention to provide an aqueous polyurethane which is useful in industrial coating or surface treatment of leather or textiles.

According to one feature of the present invention, a prepolymer is prepared by first reacting an aromatic diisocyanate with a compound containing active hydrogen and a hydrophilic group or a group capable of forming hydrophilicity, followed by adding a polyol to proceed pre-polymerization reaction. This gives a prepolymer with the hydrophilic groups or the groups capable of forming hydrophilicity evenly distributed among the prepolymer chains, and with terminal isocyanate groups, which are relatively hydrophobic, wrapped in the internal part of twisted prepolymer chains. Accordingly, the terminal isocyanate groups are less consumed when dispersing the prepolymer in water, and the chain extension can proceed to raise the molecular weight effectively.

According to another feature of the invention, the NCO content of the prepolymer dispersion is closely monitored, such that a chain extender can be added to the dispersion before a drastic reaction between the terminal NCO groups and water. Preferably, 0.1-5 wt % of the chain extender is added when the prepolymer dispersion reaches an NCO content between about 0.8-8.0 wt %. Thereby, a stable aqueous dispersion of a high-molecular weight polyurethane can be afforded. The aqueous polyurethane dispersions of the invention are generally storable at room temperature for over one year. In addition, because the polyurethane has a high molecular weight, a dried film produced therefrom generally exhibits excellent mechanical properties, for example, tensile strength of above 400 kg/cm², ultimate elongation of above 400%, 100% modulus of above 80 kg/cm² .

### DETAILED DESCRIPTION OF TH INVENTION

The aqueous polyurethane of the present invention is prepared by a prepolymer mixing process by reacting components (a), (b), and (c), followed by chain-extending the resulting prepolymer with component (d):

(a) 10-40 wt % of an aromatic diisocyanate;

(b) 1-15 wt % of a compound containing active hydrogen and a hydrophilic group or a group capable of forming hydrophilicity;

(c) 30-80 wt % of a polyol; and

(d) 0.1-5 wt % of a chain extender having active hydrogen.

The polyurethanes of the present invention are prepared in the absence of aliphatic or cycloaliphatic diisocyanates, or acrylic resins which are required in conventional methods for making aromatic diisocyanate-derived polyurethane. The diisocyanate component (a) is an aromatic diisocyanate, which costs much less than aliphatic or cycloaliphatic diisocyanates. The aromatic diisocyanate suitable for use in this invention contains at least one aromatic ring of phenyl, biphenyl, or naphthyl. The rings could also include substituents such as halogen, nitro, cyano, alkyl, alkoxyl, haloalkyl, hydroxyl, carboxyl, amido, and amino. Preferably, the aromatic diisocyanate (a) is selected from the group consisting of the compounds of formula (I) and (II) and the mixture thereof:

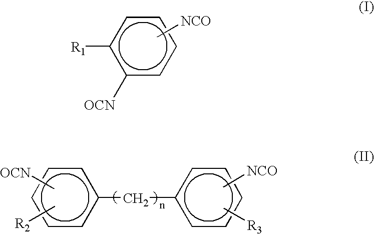

wherein R₁ is H or C₁₋₆ alkyl; each of R₂ and R₃, independently, is H, C₁₋₆ alkyl, C₁₋₆ alkoxyl, or C₆ aryl; and n is an integer of 0-3.

Representative examples of suitable aromatic diisocyanates include toluene diisocyanate (TDI), p-phenylene diisocyanate (PPDI), diphenylmethane diisocyanate (MDI), and p,p′-bisphenyl diisocyanate (BPDI). A mixture or dimers or trimers of the above are also suitable for use. For example, the aromatic diisocyanate (a) may comprise a mixture of (a1) TDI or PPDI and (a2) MDI or BPDI, wherein component (a1) preferably constitutes at least 30 mol % of the mixture. Alternatively, the aromatic diisocyanate (a) may comprise a mixture of (a1) TDI or PPDI and (a2) dimers or trimers of (a1), wherein component (a1) preferably constitutes at least 30 mol % of the mixture.

A compound containing active hydrogen and a hydrophilic group or a group capable of forming hydrophilicity is used as component (B) in preparing polyurethanes of the present invention. The hydrophilic groups include ionic groups such as —COO⁻, —SO₅⁻, and N⁺R₄ (R=alkyl), and non-ionic groups such as —(CH₂CH₂O)—. Illustrative of such compounds are dimethylol propionic acid (DMPA), dimethylol butanoic acid (DMBA), polyethylene oxide glycol, bis(hydroxylethyl) amine, and sodium 3-bis(hydroxyethyl) aminopropanesulfonate. These compounds can be used either alone or in combination.

Polyols such as diols or more highly functional polyols are used as component (c) in the present invention, including, for example, polyester polyols, polyether polyols, polycarbonate polyols, polycaprolactone polyols, and polyacrylate polyols. Illustrative of suitable polyols are poly(butanediol-co-adipate) glycol (PBA), polytetramethylene glycol (PTMEG), poly(hexanediol-co-adipate) glycol (PHA), poly(ethylene-co-adipate) glycol, (PEA), polypropylene glycol, and polyethylene glycol. These polyols can be used either alone or in combination. Preferably, the polyols used herein have a number-average molecular weight between about 200-6,000, more preferably between about 600-3,000.

The component (d) is a chain extender. The chain extender used in this invention is not specifically limited. Any conventional chain extenders having active hydrogen-containing groups may be used. Typical chain extenders include diamines, triamines, and tetraamines. Preferred chain extenders are diamines of the formula: H₂N—(CH₂)ₘ—NH₂ where m is an integer of 0-12, methyl-1,5-pentamethylene diamine, diethylene triamine (DETA), and triethylene tetraamine (TETA). A most preferred chain extender is ethylene diamine.

The present method of making an aqueous polyurethane dispersion comprises the following steps:

(A) first reacting (a) 10-40 wt % of an aromatic diisocyanate with (b) 1-15 wt % of a compound containing active hydrogen and a hydrophilic group or a group capable of forming hydrophilicity, to form a diisocyanate-terminated compound containing a hydrophilic group or a group capable of forming hydrophilicity;

(B) then reacting the diisocyanate-terminated compound with (c) 30-80 wt % of a polyol to form a prepolymer containing a hydrophilic group or a group capable of forming hydrophilicity, and optionally neutralizing the prepolymer;

(C) dispersing the prepolymer in water to form an aqueous dispersion; and

(D) chain-extending the dispersed prepolymer to obtain an aqueous polyurethane dispersion by adding thereto (d) 0.1-5 wt % of a chain extender when the aqueous dispersion has an NCO-content between about 0.8-8.0 wt %.

Step (A) is preferably carried out at a temperature between about 40-90° C., and more preferably below 60° C. If the reaction temperature is too high, the hydrophilic groups or the groups capable of forming hydrophilicity will be unevenly distributed among the prepolymer chain, thus resulting in an unstable dispersion. Prepolymerization step (B) may be carried out at the same temperature as in step (A). As the prepolymerization approaches theoretical completion, the reaction mixture is cooled to a temperature below 70° C., and when necessary, a neutralizing agent such as triethylamine (TEA) is added to give a neutralized prepolymer containing a hydrophilic group or a group capable of forming hydrophilicity. Thereafter, the prepolymer is dispersed in water, and the NCO content of the aqueous dispersion is closely monitored. A chain extender, preferably diluted with water, is added to chain-extend the prepolymer when the NCO content falls in the range between about 0.8-8.0 wt %. The chain extension can be carried out at room temperature or under heating. After forming the polyurethane dispersion, water can be added to adjust the desired solid content, which is typically in the range between about 10-55 wt %.

With the present invention, aqueous polyurethanes derived from aromatic diisocyanates with high molecular weights and excellent mechanical properties can be achieved. A polyurethane film produced thereby generally exhibits tensile strength of above 320 kg/cm², and ultimate elongation of 320%.

Without intending to limit it in any manner, the present invention will be further illustrated by the following examples.

### EXAMPLE 1

To a reaction vessel equipped with a nitrogen inlet and outlet, 14.07 g of dimethylol propionic acid (DMPA) and 33.33 g of N-methyl pyrrolidone (NMP) were added with thorough stirring. After the DMPA was completely dissolved, 67.15 g of a mixture of 80% of 2,4- and 20% of 2,6-toluene diisocyanate (TDI) was added. The mixture was stirred at 60° C. for 1.5 hour, followed by addition of 218.78 g of poly(butanediol-co-adipate) glycol (PBA; Mn=2,000) to proceed prepolymerization. After stirring at 60° C. for 4 hours, the reaction mixture was cooled to 50° C., and then 10.6 g of triethylamine (TEA) was added to neutralize the prepolymer. The neutralization was continued for 20 minutes. Thereafter, 270 g of the neutralized prepolymer was dispersed in 560 g of de-ionized water under stirring at rotor speeds of about 500 rpm. 3.04 g of ethylene diamine (EDA) was diluted with water and added to the above mixture to proceed chain extension before the NCO content of the dispersion has fallen to 1.47 wt %. The chain extension was continued at room temperature for 2 hours, giving an aqueous polyurethane dispersion with 30 wt % solid content.

The dispersion was cast into a film and dried. The dried film was glossy and transparent. The solvent resistance and mechanical properties of the polyurethane film were valuated, and the results are as follows:

Solvent Resistance (Toluene): over 100 times

Tensile strength: 323 kg/cm²

100% modulus: 88 kg/cm²

Ultimate elongation: 330%

### EXAMPLE 2

To a reaction vessel equipped with a nitrogen inlet and outlet, 14.07 g of dimethylol propionic acid (DMPA) and 33.33 g of N-methyl pyrrolidone (NMP) were added with thorough stirring. After the DMPA was completely dissolved, 67.15 g of a mixture of 80% of 2,4- and 20% of 2,6-toluene diisocyanate (TDI) was added. The mixture was stirred at 60° C. for 1.5 hour, followed by addition of 218.78 g of polytetramethylene glycol (PTMEG; Mn=1,000) to proceed prepolymerization. After stirring at 60° C. for 4 hours, the reaction mixture was cooled to 50° C., and then 10.6 g of triethylamine (TEA) was added to neutralize the prepolymer. The neutralization was continued for 20 minutes. Thereafter, 270 g of the neutralized prepolymer was dispersed in 450 g of de-ionized water under stirring at rotor speeds of about 500 rpm. 3.10 g of ethylene diamine (EDA) was diluted with water and added to the above mixture to proceed chain extension before the NCO content of the dispersion has fallen to 2.03 wt %. The chain extension was continued at room temperature for 2 hours, giving an aqueous polyurethane dispersion with 33 wt % solid content.

The dispersion was cast into a film and dried. The dried film did not dissolve in methyl ethyl ketone and toluene. The solvent resistance and mechanical properties of the polyurethane film were valuated, and the results are as follows:

Solvent Resistance (Toluene): over 300 times

Tensile strength: 450 kg/cm²

100% modulus: 60 kg/cm²

Ultimate elongation: 370%

### EXAMPLE 3

To a reaction vessel equipped with a nitrogen inlet and outlet, 12.19 g of dimethylol propionic acid (DMPA) and 28.9 g of N-methyl pyrrolidone (NMP) were added with thorough stirring. After the DMPA was completely dissolved, 28.19 g of a mixture of 80% of 2,4- and 20% of 2,6-toluene diisocyanate (TDI) was added. The mixture was stirred at 60° C. for 1.5 hour, followed by addition of 189.61 g of poly(hexanediol-co-adipate) glycol (PHA; Mn=2,000) to proceed prepolymerization. After stirring at 60° C. for 4 hours, the reaction mixture was cooled to 50° C., and then 9.2 g of triethylamine (TEA) was added to neutralize the prepolymer. The neutralization was continued for 20 minutes. Thereafter, 270 g of the neutralized prepolymer was dispersed in 400 g of de-ionized water under stirring at rotor speeds of about 500 rpm. 2.63 g of ethylene diamine (EDA) was diluted with water and added to the above mixture to proceed chain extension before the NCO content of the dispersion has fallen to 1.47 wt %. The chain extension was continued at room temperature for 2 hours, giving an aqueous polyurethane dispersion with 35 wt % solid content.

The dispersion was cast into a film and dried. The dried film did not dissolve in methyl ethyl ketone and toluene. The solvent resistance and mechanical properties of the polyurethane film were valuated, and the results are as follows:

Solvent Resistance (Toluene): over 300 times

Tensile strength: 410 kg/cm²

100% modulus: 60 kg/cM²

Ultimate elongation: 380%

### EXAMPLE 4

To a reaction vessel equipped with a nitrogen inlet and outlet, 16.88 g of dimethylol propionic acid (DMPA) and 31.1 g of N-methyl pyrrolidone (NMP) were added with thorough stirring. After the DMPA was completely dissolved, 69.75 g of a mixture of 80% of 2,4- and 20% of 2,6-toluene diisocyanate (TDI) was added. The mixture was stirred at 60° C. for 1.5 hour, followed by addition of 193.37 g of polytetramethylene glycol (PTMEG; Mn=2,000) to proceed prepolymerization. After stirring at 60° C. for 4 hours, the reaction mixture was cooled to 50° C., and then 12.7 g of triethylamine (TEA) was added to neutralize the prepolymer. The neutralization was continued for 20 minutes. Thereafter, 270 g of the neutralized prepolymer was dispersed in 490 g of de-ionized water under stirring at rotor speeds of about 500 rpm. 2.88 g of ethylene diamine (EDA) was diluted with water and added to the above mixture to proceed chain extension before the NCO content of the dispersion has fallen to 2.88 wt %. The chain extension was continued at room temperature for 2 hours, giving an aqueous polyurethane dispersion with 27 wt % solid content.

The dispersion was cast into a film and dried. The solvent resistance and mechanical properties of the polyurethane film were valuated, and the results are as follows:

Solvent Resistance (Toluene): over 600 times

Tensile strength: 400 kg/cm²

100% modulus: 80 kg/cm²

Ultimate elongation: 470%

### EXAMPLE 5

To a reaction vessel equipped with a nitrogen inlet and outlet, 6.70 g of dimethylol propionic acid (DMPA) and 50.0 g of N-methyl pyrrolidone (NMP) were added with thorough stirring. After the DMPA was completely dissolved, 25.01 g of 4,4′-diphenylmethane diisocyanate (MDI) was added. The mixture was stirred at 60° C. for 1.5 hour, followed by addition of 152.68 g of polypropylene glycol (PPG; Mn=2,000) to proceed prepolymerization. After stirring at 60° C. for 4 hours, 40.62 g of a mixture of 80% of 2,4- and 20% of 2,6-toluene diisocyanate (TDI) was added, and left stirring for additional 2.5 hours. The reaction mixture was cooled to 50° C., and then 5.05 g of triethylamine (TEA) was added to neutralize the prepolymer. The neutralization was continued for 20 minutes. Thereafter, 190 g of the neutralized prepolymer was dispersed in 182 g of de-ionized water under stirring at rotor speeds of about 500 rpm. 2.14 g of ethylene diamine (EDA) was diluted with water and added to the above mixture to proceed chain extension before the NCO content of the dispersion has fallen to 1.91 wt %. The chain extension was continued at room temperature for 2 hours, giving an aqueous polyurethane dispersion with 45 wt % solid content.

The dispersion was cast into a film and dried. The dried film did not dissolve in methyl ethyl ketone and NMP, and exhibited excellent toluene resistance (over 1,000 times).

### EXAMPLE 6

To a reaction vessel equipped with a nitrogen inlet and outlet, 10.85 g of dimethylol propionic acid (DMPA) and 50.0 g of N-methyl pyrrolidone (NMP) were added with thorough stirring. After the DMPA was completely dissolved, 34.29 g of 4,4′-diphenylmethane diisocyanate (MDI) was added. The mixture was stirred at 60° C. for 1.5 hour, followed by addition of 133.35 g of PTMEG (Mn=1,000) to proceed prepolymerization. After stirring at 60° C. for 4 hours, 35.80 g of a mixture of 80% of 2,4- and 20% of 2,6-toluene diisocyanate (TDI) was added, and left stirring for additional 2.5 hours. The reaction mixture was cooled to 50° C., and then 8.18 g of triethylamine (TEA) was added to neutralize the prepolymer. The neutralization was continued for 20 minutes. Thereafter, 200 g of the neutralized prepolymer was dispersed in 214 g of de-ionized water under stirring at rotor speeds of about 500 rpm. 1.52 g of ethylene diamine (EDA) was diluted with water and added to the above mixture to proceed chain extension before the NCO content of the dispersion has fallen to 1.53 wt %. The chain extension was continued at room temperature for 2 hours, giving an aqueous polyurethane dispersion with 20 wt % solid content.

The dispersion was cast into a film and dried. The dried film did not dissolve in methyl ethyl ketone and NMP.

### EXAMPLE 7

To a reaction vessel equipped with a nitrogen inlet and outlet, 12.06 g of dimethylol propionic acid (DMPA) and 50.0 g of N-methyl pyrrolidone (NMP) were added with thorough stirring. After the DMPA was completely dissolved, 21.47 g of 4,4′-diphenylmethane diisocyanate (MDI) was added. The mixture was stirred at 60° C. for 1.5 hour, followed by addition of 153.07 g of PTMEG (Mn=2,000) to proceed prepolymerization. After stirring at 60° C. for 4 hours, 35.80 g of a mixture of 80% of 2,4- and 20% of 2,6-toluene diisocyanate (TDI) was added, and left stirring for additional 2.5 hours. The reaction mixture was cooled to 50° C., and then 9.1 g of triethylamine (TEA) was added to neutralize the prepolymer. The neutralization was continued for 20 minutes. Thereafter, 200 g of the neutralized prepolymer was dispersed in 241 g of de-ionized water under stirring at rotor speeds of about 500 rpm. 1.51 g of ethylene diamine (EDA) was diluted with water and added to the above mixture to proceed chain extension before the NCO content of the dispersion has fallen to 1.36 wt %. The chain extension was continued at room temperature for 2 hours, giving an aqueous polyurethane dispersion with 35 wt % solid content.

The dispersion was cast into a film and dried. The dried film did not dissolve in methyl ethyl ketone (MEK) and NMP, and exhibited excellent MEK resistance (over 1,000 times).

### EXAMPLE 8

To a reaction vessel equipped with a nitrogen inlet and outlet, 10.72 g of dimethylol propionic acid (DMPA) and 80.2 g of N-methyl pyrrolidone (NMP) were added with thorough stirring. After the DMPA was completely dissolved, 40.0 g of 4,4′-diphenylmethane diisocyanate (MDI) was added. The mixture was stirred at 60° C. for 1.5 hour, followed by addition of 80 g of PBA (Mn=1,000) to proceed prepolymerization. After stirring at 60° C. for 4 hours, 27.84 g of a mixture of 80% of 2,4- and 20% of 2,6-toluene diisocyanate (TDI) was added, and left stirring for additional 2.5 hours. The reaction mixture was cooled to 50° C., and then 9.87 g of triethylamine (TEA) was added to neutralize the prepolymer. The neutralization was continued for 20 minutes. Thereafter, 190 g of the neutralized prepolymer was dispersed in 465 g of de-ionized water under stirring at rotor speeds of about 500 rpm. 2.86 g of ethylene diamine (EDA) was diluted with water and added to the above mixture to proceed chain extension before the NCO content of the dispersion has fallen to 1.82 wt %. The chain extension was continued at room temperature for 2 hours, giving an aqueous polyurethane dispersion with 20 wt % solid content.

The dispersion was cast into a film and dried. The dried film was transparent and did not dissolve in MEK and NMP.

### EXAMPLE 9

To a reaction vessel equipped with a nitrogen inlet and outlet, 26.8 g of dimethylol propionic acid (DMPA) and 43.3 g of N-methyl pyrrolidone (NMP) were added with thorough stirring. After the DMPA was completely dissolved, 37.5 g of 4,4′-diphenylmethane diisocyanate (MDI) was added. The mixture was stirred at 60° C. for 1.5 hour, followed by addition of 100.0 g of PBA (Mn=1,000) to proceed prepolymerization. After stirring at 60° C. for 4 hours, 43.5 g of a mixture of 80% of 2,4- and 20% of 2,6-toluene diisocyanate (TDI) was added, and left stirring for additional 2.5 hours. The reaction mixture was cooled to 50° C., and then 20.2 g of triethylamine (TEA) was added to neutralize the prepolymer. The neutralization was continued for 20 minutes. Thereafter, 180 g of the neutralized prepolymer was dispersed in 540 g of de-ionized water under stirring at rotor speeds of about 500 rpm. 1.28 g of ethylene diamine (EDA) was diluted with water and added to the above mixture to proceed chain extension before the NCO content of the dispersion has fallen to 1.17 wt %. The chain extension was continued at room temperature for 2 hours, giving an aqueous polyurethane dispersion with 20 wt % solid content.

The dispersion was cast into a film and dried. The dried film did not dissolve in methyl ethyl ketone (MEK) and NMP, and exhibited excellent toluene resistance (over 1,000 times).

### EXAMPLE 10

To a reaction vessel equipped with a nitrogen inlet and outlet, 16.80 g of dimethylol propionic acid (DMPA) and 40.0 g of N-methyl pyrrolidone (NMP) were added with thorough stirring. After the DMPA was completely dissolved, 40.0 g of 4,4′-diphenylmethane diisocyanate (MDI) was added. The mixture was stirred at 60° C. for 1.5 hour, followed by addition of 80.0 g of PTMEG (Mn=1,000) to proceed prepolymerization. After stirring at 60° C. for 4 hours, 27.84 g of a mixture of 80% of 2,4- and 20% of 2,6-toluene diisocyanate (TDI) was added, and left stirring for additional 2.5 hours. The reaction mixture was cooled to 50° C., and then 9.87 g of triethylamine (TEA) was added to neutralize the prepolymer. The neutralization was continued for 20 minutes. Thereafter, 150 g of the neutralized prepolymer was dispersed in 450 g of de-ionized water under stirring at rotor speeds of about 500 rpm. 2.10 g of ethylene diamine (EDA) was diluted with water and added to the above mixture to proceed chain extension before the NCO content of the dispersion has fallen to 1.73 wt %. The chain extension was continued at room temperature for 2 hours, giving an aqueous polyurethane dispersion with 20 wt % solid content.

The dispersion was cast into a film and dried. The mechanical properties of the polyurethane film were valuated, and the results are as follows:

Tensile strength: 400 kg/cm²

100% modulus. 160 kg/cm²

Ultimate elongation: 330%

### EXAMPLE 11

To a reaction vessel equipped with a nitrogen inlet and outlet, 13.4 g of dimethylol propionic acid (DMPA) and 36.2 g of N-methyl pyrrolidone (NMP) were added with thorough stirring. After the DMPA was completely dissolved, 40.0 g of 4,4′-diphenylmethane diisocyanate (MDI) was added. The mixture was stirred at 60° C. for 1.5 hour, followed by addition of 100.0 g of PTMEG (Mn=1,000) to proceed prepolymerization. After stirring at 60° C. for 4 hours, 34.8 g of a mixture of 80% of 2,4- and 20% of 2,6-toluene diisocyanate (TDI) was added, and left stirring for additional 2.5 hours. The reaction mixture was cooled to 50° C., and then 10.1 g of triethylamine (TEA) was added to neutralize the prepolymer. The neutralization was continued for 20 minutes. Thereafter, 150 g of the neutralized prepolymer was dispersed in 690 g of de-ionized water under stirring at rotor speeds of about 500 rpm. 2.86 g of ethylene diamine (EDA) was diluted with water and added to the above mixture to proceed chain extension before the NCO content of the dispersion has fallen to 2.10 wt %. The chain extension was continued at room temperature for 2 hours, giving an aqueous polyurethane dispersion with 15 wt % solid content.

The dispersion was cast into a film and dried. The dried film did not dissolved in MEK and NMP. The solvent resistance and the mechanical properties of the polyurethane film were valuated, and the results are as follows:

Solvent Resistance (Toluene): over 1,000 times

Tensile strength: 400 kg/cm²

100% modulus: 160 kg/cm²

Ultimate elongation: 330%

### EXAMPLE 12

In a reaction vessel equipped with a nitrogen inlet and outlet, 5.63 g of dimethylol propionic acid (DMPA) were added to 127.13 g of a mixture of 80% of 2,4- and 20% of 2,6-toluene diisocyanate (TDI). The mixture was stirred at 60° C. for 1.5 hour, followed by addition of 117.84 g of PPG (Mn=600) to proceed prepolymerization. After stirring at 60° C. for 4 hours the reaction mixture was cooled to 50° C., and then 4.2 g of triethylamine (TEA) was added to neutralize the prepolymer. The neutralization was continued for 20 minutes. Thereafter, 160 g of the neutralized prepolymer was dispersed in 630 g of de-ionized water under stirring at rotor speeds of about 500 rpm. 4.13 g of ethylene diamine (EDA) was diluted with water and added to the above mixture to proceed chain extension before the NCO content of the dispersion has fallen to 4.62 wt %. The chain extension was continued at room temperature for 2 hours, giving an aqueous polyurethane dispersion with 20 wt % solid content.

### EXAMPLE 13

In a reaction vessel equipped with a nitrogen inlet and outlet, 5.63 g of dimethylol propionic acid (DMPA) were added to 151.69 g of a mixture of 80% of 2,4- and 20% of 2,6-toluene diisocyanate (TDI). The mixture was stirred at 60° C. for 1.5 hour, followed by addition of 122.68 g of PPG (Mn=600) to proceed prepolymerization. After stirring at 60° C. for 4 hours, the reaction mixture was cooled to 50° C., and then 5.0 g of triethylamine (TEA) was added to neutralize the prepolymer. The neutralization was continued for 20 minutes. Thereafter, 180 g of the neutralized prepolymer was dispersed in 700 g of de-ionized water under stirring at rotor speeds of about 500 rpm. 5.57 g of ethylene diamine (EDA) was diluted with water and added to the above mixture to proceed chain extension before the NCO content of the dispersion has fallen to 5.41 wt %. The chain extension was continued at room temperature for 2 hours, giving an aqueous polyurethane dispersion with 20 wt % solid content. The dispersion was cast into a film and dried. The dried film exhibited excellent toluene resistance (over 1,000 times).

While the invention has been particularly shown and described with reference to the preferred embodiment thereof, it will be understood by those skilled in the art that various changes in form and details may be made without departing from the spirit and scope of the invention.

What is claimed is:

1. An aqueous polyurethane, prepared by forming a hydrophilic prepolymer by reacting components (a), (b), and (c) in the absence of aliphatic or cycloaliphatic diisocyanates, and chain-extending the hydrophilic prepolymer with component (d):
(a) 10-40 wt % of an aromatic diisocyanate;
(b) 1-15 wt % of a compound containing active hydrogen and a hydrophilic group or a group capable of forming hydrophilicity;
(c) 30-80 wt % of a polyol; and
(d) 0.1-5 wt % of a chain extender having active hydrogen.

2. The aqueous polyurethane as claimed in claim 1, wherein the aromatic diisocyanate contains at least one aromatic ring of phenyl, biphenyl, or naphthyl.

3. The aqueous polyurethane as claimed in claim 1, wherein the aromatic diisocyanate is selected from the group consisting of the compounds of formula (I) and (II) and the mixture thereof: 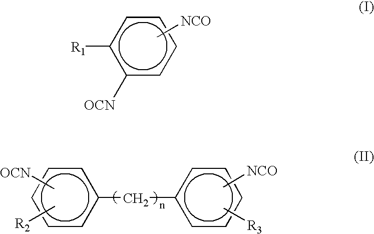
wherein R₁ is H or C₁₋₆ alkyl; each of R₂ and R₃, independently, is H, C₁₋₆ alkyl, C₁₋₆ alkoxyl, or C₆ aryl; and n is an integer of 0-3.

4. The aqueous polyurethane as claimed in claim 1, wherein the aromatic diisocyanate comprises toluene diisocyanate (TDI).

5. The aqueous polyurethane as claimed in claim 1, wherein the aromatic diisocyanate comprises p-phenylene diisocyanate (PPDI).

6. The aqueous polyurethane as claimed in claim 1, wherein the aromatic diisocyanate comprises 4,4′-diphenylmethane diisocyanate (MDI).

7. The aqueous polyurethane as claimed in claim 1, wherein the aromatic diisocyanate comprises p,p′-bisphenyl diisocyanate (BPDI).

8. The aqueous polyurethane as claimed in claim 1, wherein the aromatic diisocyanate comprises a mixture of a diisocyanate monomers and dimers or trimers thereof.

9. The aqueous polyurethane as claimed in claim 1, wherein the aromatic diisocyanate comprises a mixture of (a1) TDI or PPDI and (a2) MDI or BPDI, and (a1) constitutes at least 30 mol % of the mixture.

10. The aqueous polyurethane as claimed in claim 1, wherein the aromatic diisocyanate comprises a mixture of (a1) TDI or PPDI and (a2) dimers or trimers of (a1), and (a1) constitutes at least 30 mol % of the mixture.

11. The aqueous polyurethane as claimed in claim 1, wherein the polyol has a number-average molecular weight of about 200-6,000.

12. The aqueous polyurethane as claimed in claim 1, wherein the polyol is selected from the group consisting of polyester polyols, polyether polyols, polycarbonate polyols, polycaprolactone polyols, polyacrylate polyols, and mixtures thereof.

13. The aqueous polyurethane as claimed in claim 1, wherein (b) the compound containing active hydrogen is capable of forming a hydrophilic group selected from the group consisting of —COO⁻, —SO₃⁻, N⁺R₄ where R is alkyl, —(CH₂CH₂O)—, and mixtures thereof.

14. The aqueous polyurethane as claimed in claim 1, wherein (b) the compound containing active hydrogen is selected from the group consisting of dimethylol propionic acid (DMPA), dimethylol butanoic acid (DMPA), polyethylene oxide glycol, bis(hydroxylethyl) amine, sodium 3-bis(hydroxyethyl) aminopropanesulfonate, and mixtures thereof.

15. The aqueous polyurethane as claimed in claim 1, wherein the chain extender is a diamine, triamine, or tetraamine.

16. The aqueous polyurethane as claimed in claim 1, wherein the chain extender is selected from the group consisting of H₂N—(CH₂)ₘ—NH₂ where m is an integer of 0-12, methyl-1,5-pentamethylene diamine, diethylene triamine (DETA), and triethylene tetraamine (TETA).

17. A dried film of the aqueous polyurethane as claimed in claim 1, which exhibits a tensile strength above 320 kg/cm² and an ultimate elongation of above 320%.

18. An aqueous polyurethane, prepared by
(A) first reacting (a) 10-40 wt % of an aromatic diisocyanate with (b) 1-15 wt % of a compound containing active hydrogen and a hydrophilic group or a group capable of forming hydrophilicity, to form a diisocyanate-terminated compound containing a hydrophilic group or a group capable of forming hydrophilicity;
(B) then reacting the diisocyanate-terminated compound with (c) 30-80 wt % of a polyol to form a prepolymer containing a hydrophilic group or a group capable of forming hydrophilicity, and optionally neutralizing the prepolymer;
(C) dispersing the prepolymer in water to form an aqueous dispersion; and
(D) chain-extending the dispersed prepolymer to obtain an aqueous polyurethane dispersion by adding thereto (d) 0.1-5 wt % of a chain extender when the aqueous dispersion has an NCO-content between about 0.8-8.0 wt %.

19. The aqueous polyurethane as claimed in claim 18, wherein the step (A) is conducted at a temperature of about 40-90° C.

20. The aqueous polyurethane as claimed in claim 18, wherein the aromatic diisocyanate is selected from the group consisting of the compounds of formula (I) and (II) and the mixture thereof: 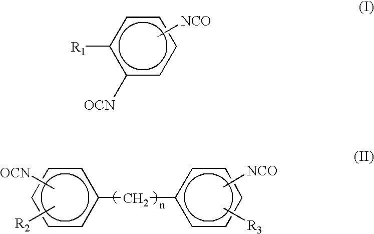
wherein R₁ is H or C₁₋₆ alkyl; each of R₂ and R₃, independently, is H, C₁₋₆ alkyl, C₁₋₆ alkoxyl, or C₆ aryl; and n is an integer of 0-3.

21. The aqueous polyurethane as claimed in claim 18, wherein the aromatic diisocyanate comprises toluene diisocyanate (TDI).

22. The aqueous polyurethane as claimed in claim 18, wherein the aromatic diisocyanate comprises p-phenylene diisocyanate (PPDI).

23. The aqueous polyurethane as claimed in claim 18, wherein the aromatic diisocyanate comprises 4,4′-diphenylmethane diisocyanate (MDI).

24. The aqueous polyurethane as claimed in claim 18, wherein the aromatic diisocyanate comprises p,p′-bisphenyl diisocyanate (BPDI).

25. The aqueous polyurethane as claimed in claim 18, wherein the aromatic diisocyanate comprises a mixture of a diisocyanate monomers and dimers or trimers thereof.

26. The aqueous polyurethane as claimed in claim 18, wherein the aromatic diisocyanate comprises a mixture of (a1) TDI or PPDI and (a2) MDI or BPDI, and (a1) constitutes at least 30 mol % of the mixture.

27. The aqueous polyurethane as claimed in claim 18, wherein the aromatic diisocyanate comprises a mixture of (a1) TDI or PPDI and (a2) dimers or trimers of (a1), and (a1) constitutes at least 30 mol % of the mixture.

28. The aqueous polyurethane as claimed in claim 18, wherein the polyol has a number-average molecular weight of about 200-6,000.

29. The aqueous polyurethane as claimed in claim 18, wherein the polyol is selected from the group consisting of polyester polyols, polyether polyols, polycarbonate polyols, polycaprolactone polyols, polyacrylate polyols, and mixtures thereof.

30. The aqueous polyurethane as claimed in claim 18, wherein (b) the compound containing active hydrogen is capable of forming a hydrophilic group selected from the group consisting of —COO⁻, —SO₃⁻, N⁺R₄ where R is alkyl, —(CH₂CH₂O)—, and mixtures thereof.

31. The aqueous polyurethane as claimed in claim 18, wherein (b) the compound containing active hydrogen is selected from the group consisting of dimethylol propionic acid (DMPA), dimethylol butanoic acid (DMBA), polyethylene oxide glycol, bis(hydroxylethyl) amine, sodium 3-bis(hydroxyethyl) aminopropanesulfonate, and mixtures thereof.

32. The aqueous polyurethane as claimed in claim 18, wherein the chain extender is a diamine, triamine, or tetraamine.

33. The aqueous polyurethane as claimed in claim 18, wherein the chain extender is selected from the group consisting of H₂N—(CH₂)ₘ—NH₂ where m is an integer of 0-12, methyl-1,5-pentamethylene diamine, diethylene triamine (DETA), and triethylene tetraamine (TETA).

34. A dried film of the aqueous polyurethane as claimed in claim 18, which exhibits a tensile strength above 320 kg/cm² and an ultimate elongation of above 320%.

35. A method of making an aqueous polyurethane dispersion, comprising the steps of:
(A) first reacting (a) 10-40 wt % of an aromatic diisocyanate with (b) 1-15 wt % of a compound containing active hydrogen and a hydrophilic group or a group capable of forming hydrophilicity, to form a diisocyanate-terminated compound containing a hydrophilic group or a group capable of forming hydrophilicity;
(B) then reacting the diisocyanate-terminated compound with (c) 30-80 wt % of a polyol to form a prepolymer containing a hydrophilic group or a group capable of forming hydrophilicity, and optionally neutralizing the prepolymer;
(C) dispersing the prepolymer in water to form an aqueous dispersion; and
(D) chain-extending the dispersed prepolymer to obtain an aqueous polyurethane dispersion by adding thereto (d) 0.1-5 wt % of a chain extender when the aqueous dispersion has an NCO-content between about 0.8-8.0 wt %.

36. The method as claimed in claim 35, wherein the step (A) is conducted at a temperature of about 40-90° C.

37. The method as claimed in claim 35, wherein the aromatic diisocyanate is selected from the group consisting of the compounds of formula (I) and (II) and the mixture thereof: 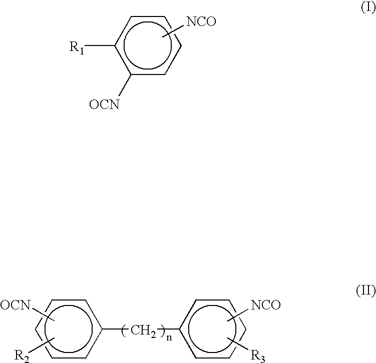
wherein R₁ is H or C₁₋₆ alkyl; each of R₂ and R₃, independently, is H, C₁₋₆ alkyl, C₁₋₆ alkoxyl, or C₆ aryl; and n is an integer of 0-3.

38. The Method as claimed in claim 35, wherein the aromatic diisocyanate comprises toluene diisocyanate (TDI).

39. The method as claimed in claim 35, wherein the aromatic diisocyanate comprises p-phenylene diisocyanate (PPDI).

40. The method as claimed in claim 35, wherein the aromatic diisocyanate comprises 4,4′-diphenylmethane diisocyanate (MDI).

41. The method as claimed in claim 35, wherein the aromatic diisocyanate comprises p,p′-bisphenyl diisocyanate (BPDI).

42. The method as claimed in claim 35, wherein the aromatic diisocyanate comprises a mixture of a diisocyanate monomers an dimers or trimers thereof.

43. The method as claimed in claim 34, wherein the aromatic diisocyanate comprises a mixture of (a1) TDI or PPDI and (a2) MDI or BPDI, and (a1) constitutes at least 30 mol % of the mixture.

44. The method as claimed in claim 35, wherein the aromatic diisocyanate comprises a mixture of (a1) TDI or PPDI and (a2) dimers or trimers of (a1), and (a1) constitutes at least 30 mol % of the mixture.

45. The method as claimed in claim 35, wherein the polyol has a number-average molecular weight of about 200-6,000.

46. The method as claimed in claim 35, wherein the polyol is selected from the group consisting of polyester polyols, polyether polyols, polycarbonate polyols, polycaprolactone polyols, polyacrylate polyols, and mixtures thereof.

47. The method as claimed in claim 35, wherein (b: the compound containing active hydrogen is capable of forming a hydrophilic group selected from the group consisting of —COO⁻, —SO₃⁻, N⁺R₄ where R is alkyl, —(CH₂CH₂O)—, and mixtures thereof.

48. The method as claimed in claim 35, wherein (b) the compound containing active hydrogen is selected from the group consisting of dimethylol propionic acid (DMPA), dimethylol butanoic acid (DMBA), polyethylene oxide glycol, bis(hydroxylethyl) amine, sodium 3-bis(hydroxyethyl) aminopropanesulfonate, and mixtures thereof.

49. The method as claimed in claim 18, wherein the chain extender is a diamine, triamine, or tetraamine.

50. The method as claimed in claim 18, wherein the chain extender is selected from the group consisting of H₂N—(CH₂)ₘ—NH₂ where m is an integer of 0-12, methyl-1,5-pentamethylene diamine, diethylene triamine (DETA), and triethylene tetraamine (TETA).
